(19) United States
(12) Patent Application Publication
(10) Pub. No.: US 2019/0015965 A1
(43) Pub. Date: Jan. 17, 2019

(54) Motorcycle Stand Assembly

(71) Applicant: Walter Nardi, Bridgewater, MA (US)

(72) Inventor: Walter Nardi, Bridgewater, MA (US)

(21) Appl. No.: 15/649,007

(22) Filed: Jul. 13, 2017

(51) Int. Cl. B25H 1/00; B62H 3/02; B62H 3/04

(52) U.S. Cl. CPC B25H 1/0014; B62H 3/04; B62H 3/02

(57) ABSTRACT

A motorcycle stand assembly includes a first panel that is selectively positioned on a support surface. A second panel extending away from the first panel and the second panel is selectively positioned on the support surface. A tire of a vehicle is selectively rolled onto the second panel. A pair of fasteners is each coupled to and extends upwardly from the second surface of the first panel. A pair of straps is selectively coupled between the fasteners and the vehicle to retain the vehicle in an upright orientation on the second panel. A first prominence extends upwardly from the second panel. The first prominence has a tire slot therein and the tire is selectively positioned therein.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art including information disclosed under 37 CFR 1.97 and 1.98

The disclosure and prior art relates to stand devices and more particularly pertains to a new stand device for retaining a motorcycle in an upright position for service and maintenance.

### BRIEF SUMMARY OF THE INVENTION

An embodiment of the disclosure meets the needs presented above by generally comprising a first panel that is selectively positioned on a support surface. A second panel extending away from the first panel and the second panel is selectively positioned on the support surface. A tire of a vehicle is selectively rolled onto the second panel. A pair of fasteners is each coupled to and extends upwardly from the second surface of the first panel. A pair of straps is selectively coupled between the fasteners and the vehicle to retain the vehicle in an upright orientation on the second panel. A first prominence extends upwardly from the second panel. The first prominence has a tire slot therein and the tire is selectively positioned therein.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a motorcycle stand assembly according to an embodiment of the disclosure.

FIG. 2 is a bottom view of an embodiment of the disclosure.

FIG. 3 is a top view of an embodiment of the disclosure.

FIG. 4 is a right side view of an embodiment of the disclosure.

FIG. 5 is a perspective in-use view of an embodiment of the disclosure.

### DETAILED DESCRIPTION OF THE INVENTION

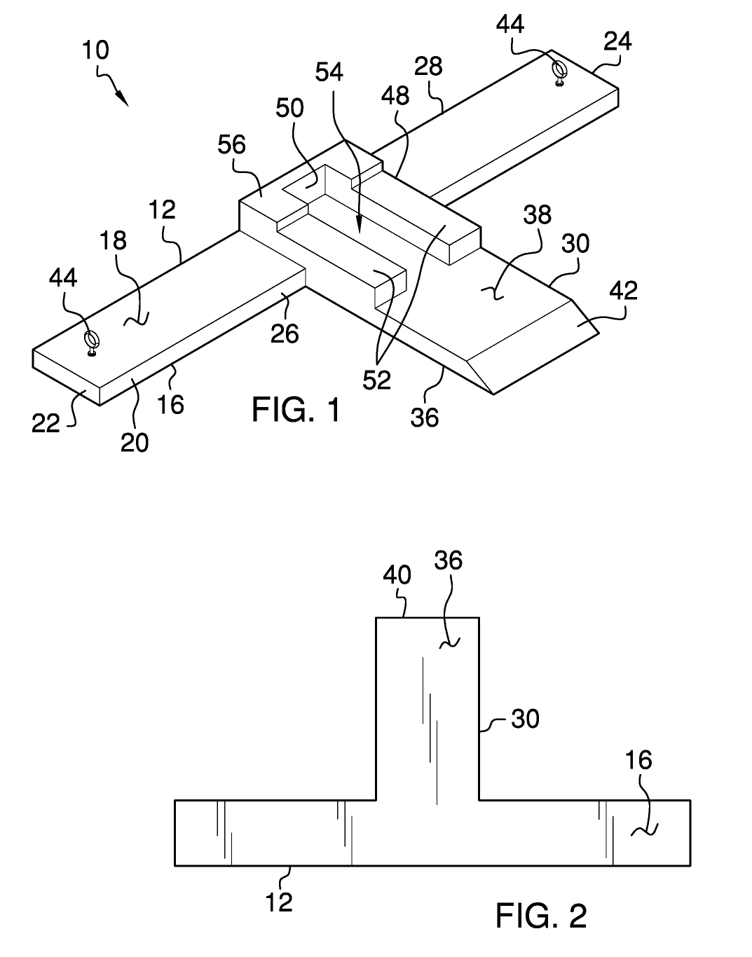

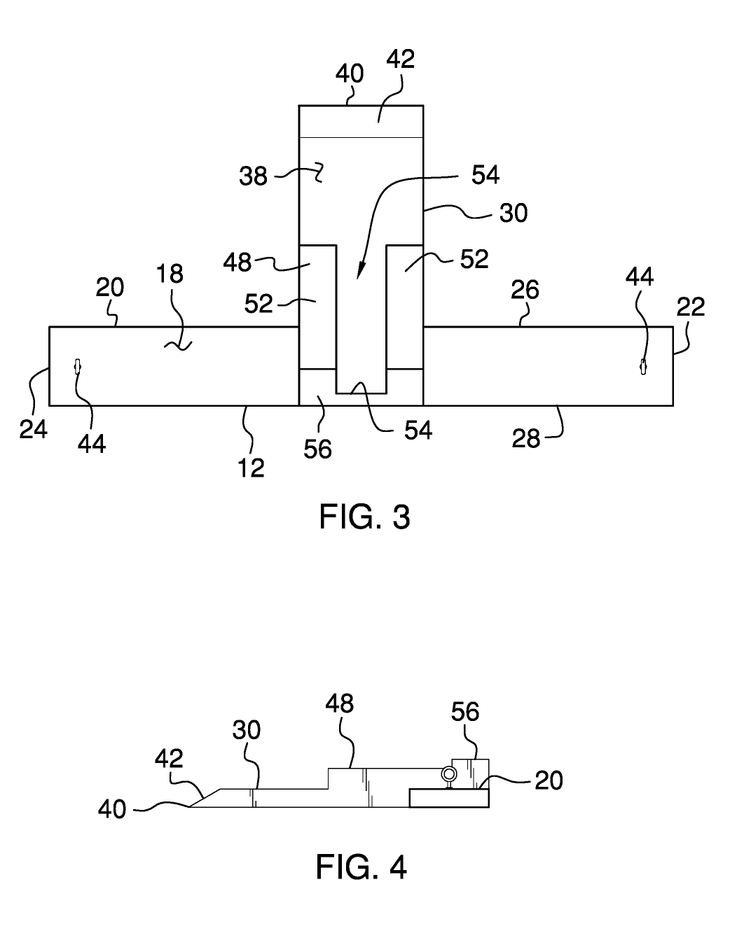

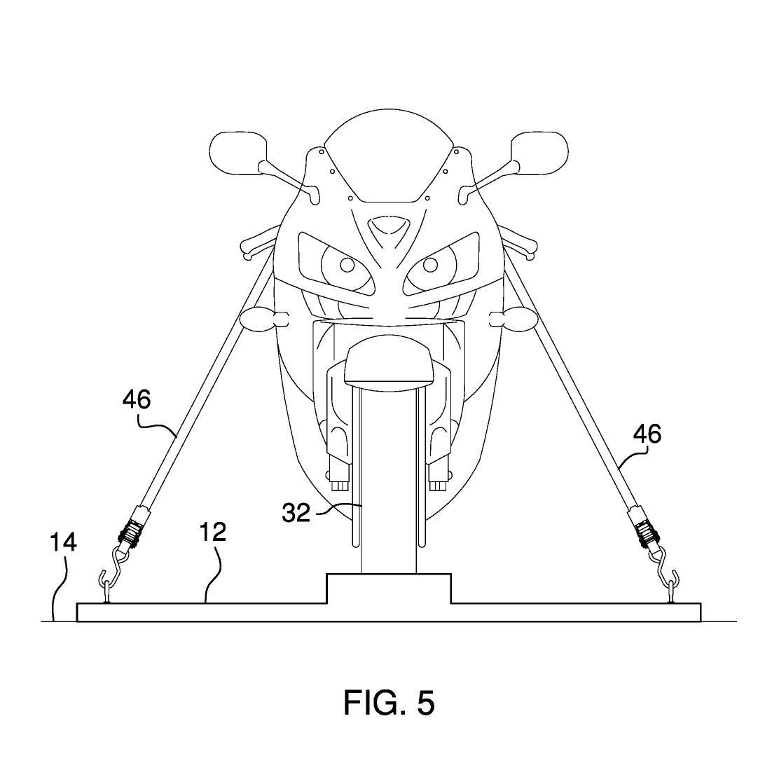

With reference now to the drawings, and in particular to FIGS. 1 through 5 thereof, a new stand device embodying the principles and concepts of an embodiment of the disclosure and generally designated by the reference numeral 10 will be described.

As best illustrated in FIGS. 1 through 5, the motorcycle stand assembly 10 generally comprises a first panel 12 that may be positioned on a support surface 14. The first panel 12 has a first surface 16, a second surface 18 and a peripheral edge 20 extending therebetween. The first surface 16 abuts the support surface 14 and the support surface 14 may be ground. The peripheral edge 20 has a first lateral side 22, a second lateral side 24, a front side 26 and a back side 28. The first panel 12 is elongated between the first 22 and second 24 lateral sides. Moreover, the first panel 12 may have a length ranging between approximately 125.0 cm and 155.0 cm.

A second panel 30 extends away from the first panel 12 and the second panel 30 is positioned on the support surface 14 when the first panel 12 is positioned on the support surface 14. A tire 32 of a vehicle 34 is positioned on the second panel 30 and the vehicle 34 may be a motorcycle and any other two wheeled vehicle. The second panel 30 has a primary surface 36, a secondary surface 38 and a distal end 40 with respect to the first panel 12. The primary surface 36 abuts the support surface 14 and the tire 32 is positioned on the secondary surface 38. The second panel 30 is centrally positioned on the front side 26 of the first panel 12 and the second panel 30 is oriented perpendicular to the first panel 12. Additionally, the secondary surface 38 slopes downwardly toward the distal end 40 to define a ramp 42 to facilitate the tire 32 to roll onto the secondary surface 38.

A pair of fasteners 44 is provided and each of the fasteners 44 is coupled to and extends upwardly from the second surface 18 of the first panel 12. The first fasteners 44 are spaced apart from each other. A pair of straps 46, such as ratchet straps or the like, are selectively coupled between the fasteners 44 and the vehicle 34 to retain the vehicle 34 in an upright orientation on the second panel 30. In this way the vehicle 34 is positioned for maintenance or the like. Each of the fasteners 44 may be eye bolts or the like.

A first prominence 48 extends upwardly from the secondary surface 38 of the second panel 30. The first prominence 48 has a central section 50 extending between a pair of lateral sections 52. The lateral sections 52 are spaced apart from each other to define a tire slot 54 between the lateral sections 52. The tire 32 is positioned in the tire slot 54 when the vehicle 34 is rolled onto the second panel 30. In this way the tire 32 is inhibited from sliding laterally on the second panel 30. The central section 50 is oriented collinear with back side 28 of the first panel 12 and each of the lateral sections 52 extends toward the distal end 40 of the secondary panel. A second prominence 56 extends upwardly from the first prominence 48. The second prominence 56 is coextensive with the central section 50 and extends partially along each of the lateral sections 52.

In use, the first 12 and second 30 panels are placed on the support surface 14 when the vehicle 34 needs to be serviced and maintained. The front tire 32 of the vehicle 34 is rolled onto the second panel 30 and the front tire 32 is positioned in the tire slot 54. The straps 46 are coupled between the vehicle 34 and associated ones of the fasteners 44 to retain the vehicle 34 in an upright orientation. In this way the vehicle 34 is retained in the upright position for service and maintenance without using a kickstand and other support that could potentially obstruct access to the vehicle 34. Each of the straps 46 is removed from the vehicle 34 and the vehicle 34 is rolled off of the second panel 30 when the service and maintenance are complete.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorcycle stand assembly being configured to retain a motorcycle in an upright position, said assembly comprising:
a first panel being configured to be positioned on a support surface;
a second panel extending away from said first panel wherein said second panel is configured to be positioned on the support surface, said second panel being configured to have a tire of a vehicle being positioned thereon;
a pair of fasteners, each of said fasteners being coupled to and extending upwardly from said second surface of said first panel, each of said fasteners being configured to have a strap coupled between said fasteners and the vehicle to retain the vehicle in an upright orientation on said second panel; and
a first prominence extending upwardly from said second panel, said first prominence having a defining a tire slot wherein said tire slot is configured to have the tire positioned therein.

2. The assembly according to claim 1, wherein said first panel has a first surface, a second surface and a peripheral edge extending therebetween, said first surface being configured to abut the support surface, said peripheral edge having a first lateral side, a second lateral side, a front side and a back side, said first panel being elongated between said first and second lateral sides.

3. The assembly according to claim 2, wherein said second panel has a primary surface, a secondary surface and a distal end with respect to said first panel, said primary surface being configured to abut the support surface, said secondary surface being configured to have the tire positioned thereon, said second panel being centrally positioned on said front side of said first panel, said second panel being oriented perpendicular to said first panel.

4. The assembly according to claim 3, wherein said secondary surface slopes downwardly toward said distal end to define a ramp wherein said ramp is configured to facilitate the tire to roll onto said secondary surface.

5. The assembly according to claim 2, wherein said first prominence has a central section extending between a pair of lateral sections, said lateral sections being spaced apart from each other to define said tire slot between said lateral sections, said central section being oriented collinear with back side of said first panel, each of said lateral sections extending toward a distal end of said secondary panel.

6. The assembly according to claim 5, further comprising a second prominence extending upwardly from said first prominence, said second prominence being coextensive with said central section and extending partially along each of said lateral sections.

7. A motorcycle stand assembly being configured to retain a motorcycle in an upright position, said assembly comprising:
a first panel being configured to be positioned on a support surface, said first panel having a first surface, a second surface and a peripheral edge extending therebetween, said first surface being configured to abut the support surface, said peripheral edge having a first lateral side, a second lateral side, a front side and a back side, said first panel being elongated between said first and second lateral sides;
a second panel extending away from said first panel wherein said second panel is configured to be positioned on the support surface, said second panel being configured to have a tire of a vehicle being positioned thereon, said second panel having a primary surface, a secondary surface and a distal end with respect to said first panel, said primary surface being configured to abut the support surface, said secondary surface being configured to have the tire positioned thereon, said second panel being centrally positioned on said front side of said first panel, said second panel being oriented perpendicular to said first panel, said secondary surface sloping downwardly toward said distal end to define a ramp wherein said ramp is configured to facilitate the tire to roll onto said secondary surface;
a pair of fasteners, each of said fasteners being coupled to and extending upwardly from said second surface of said first panel, said first fasteners being spaced apart from each other, each of said fasteners being configured to have a strap coupled between said fasteners and the vehicle to retain the vehicle in an upright orientation on said second panel;
a first prominence extending upwardly from said secondary surface of said second panel, said first prominence having a central section extending between a pair of lateral sections, said lateral sections being spaced apart from each other to define a tire slot between said lateral sections wherein said tire slot is configured to have the tire positioned therein, said central section being oriented collinear with back side of said first panel, each of said lateral sections extending toward said distal end of said secondary panel; and
a second prominence extending upwardly from said first prominence, said second prominence being coextensive with said central section and extending partially along each of said lateral sections.
